(19) United States
(12) Patent Application Publication
(10) Pub. No.: US 2021/0039189 A1
(43) Pub. Date: Feb. 11, 2021

(54) RESISTANCE-SPOT-WELDED ALUMINUM JOINT

(71) Applicant: Kabushiki Kaisha Kobe Seiko Sho (Kobe Steel, Ltd.), Kobe-shi (JP)

(72) Inventors: Takashi GOTO, Fujisawa-shi (JP); Yoshihaya IMAMURA, Fujisawa-shi (JP)

(73) Assignee: Kabushiki Kaisha Kobe Seiko Sho (Kobe Steel, Ltd.), Kobe-shi (JP)

(21) Appl. No.: 16/987,465

(22) Filed: Aug. 7, 2020

(30) Foreign Application Priority Data
Aug. 9, 2019 (JP) 2019-147595

(51) Int. Cl. B23K 11/11

(52) U.S. Cl. CPC B23K 11/11; B23K 2103/10

(57) ABSTRACT

A resistance-spot-welded aluminum joint having a type of a nugget that can reduce variations in cross tension strength. The resistance-spot-welded aluminum joint is obtained by layering a plurality of aluminum members and welding the aluminum members together by resistance spot welding. In a cross section of an interface between the aluminum members, a weld nugget formed as a result of the resistance spot welding has a plurality of blowholes aggregated in a central area of the weld nugget within the interface. In a cross section taken in a layered direction of the aluminum members extending through the center of the weld nugget, a blowhole with a maximum size of the plurality of blowholes is formed at a position where the blowhole extends through a center line of the weld nugget extending in the layered direction.

### BACKGROUND OF THE INVENTION

### 1. Field of the Invention

The present invention relates to resistance-spot-welded aluminum joints.

### 2. Description of the Related Art

Aluminum members have low electric resistance and high thermal conductivity. Therefore, in order to perform resistance spot welding, an electric current that is about three times that in the case of a steel member has to be applied, and a pressing force of electrodes for spot welding has to be increased by about 1.5 times. Furthermore, blowholes tend to form easily in aluminum members, as compared with steel members. The occurrence of blowholes is notable especially in 6000-series and 5000-series aluminurn alloys.

Normally, the joint strength of a spot-welded joint is evaluated based on, for example, tensile shear strength (TSS) and cross tension strength (CTS). In the design of a structure to which resistance spot welding is applied, it is desired that the TSS and CTS values be stable within a fixed range without variations.

However, if the members to be welded together are aluminum members, blowholes tend to form easily therein, as mentioned above. When the number of weld points for resistance spot welding increases, the state of electric-current application changes in accordance with a change in the shape of electrode tips (i.e., abrasion of the electrodes), causing the CTS to vary significantly.

A known method for evaluating a spot-welded joint disclosed in, for example, Japanese Unexamined Patent Application Publication No. 2018-161659 involves forming a drill hole through a nugget in the thickness direction of a joint body, evaluating the TSS and the CTS, and setting the welding conditions in accordance with the evaluation result.

### SUMMARY OF THE INVENTION

The method for evaluating a spot-welded joint disclosed in Japanese Unexamined Patent Application Publication No. 2018-161659 involves forming a through-hole with a fixed area in the nugget and estimating the strength of the spot-welded joint. However, in a spot-welded aluminum joint, even if a through-hole mimicking a blowhole and having substantially the same area is formed, there is a problem in that the CTS varies significantly and is not stable.

An object of the present invention is to provide a resistance-spot-welded aluminum joint having a type of a nugget that can reduce variations in the CTS.

The present invention has the following configuration.

A resistance-spot-welded aluminum joint is obtained by layering a plurality of aluminum members and welding the aluminum members together by resistance spot welding. In a cross section of an interface between the aluminum members, a weld nugget formed as a result of the resistance spot welding has a plurality of blowholes aggregated in a central area of the weld nugget within the interface. In a cross section taken in a layered direction of the aluminum members extending through a center of the weld nugget, a blowhole with a maximum size of the plurality of blowholes is formed at a position where the blowhole extends through a center line of the weld nugget extending in the layered direction.

According to the present invention, variations in the CTS with respect to a weld nugget formed as a result of welding aluminum members together by resistance spot welding can be reduced, so that a high-strength spot-welded aluminum joint can be obtained.

### BRIEF DESCRIPTION OF THE DRAWINGS

FIG. 1 schematically illustrates the configuration of a spot welding device that welds aluminum members together by resistance spot welding;

FIG. 2 is a cross-sectional view schematically illustrating a state where a weld nugget is formed by layering a first aluminum plate and a second aluminum plate and welding the two plates together by spot welding;

FIG. 3 is a cross-sectional view schematically illustrating the weld nugget, taken along line P-P in FIG. 2 indicating the interface between the aluminum members;

FIG. 4 is a cross-sectional plan view schematically illustrating the weld nugget, taken along line P-P in FIG. 2 indicating the interface between the aluminum members;

FIG. 5 is a timing chart illustrating an example of a waveform of a weld current;

FIGS. 6A and 6B schematically illustrate the state of the nugget from main electric-current application at a first stage to pulsation electric-current application at a second stage;

FIG. 7 is a graph illustrating peel strength based on a CTS test at each sampling weld point sampled for every predetermined number of weld points by repeatedly performing spot welding;

FIG. 8 is a graph illustrating a test result shown in FIG. 7 as a distribution of the peel strength relative to the nugget diameter;

FIG. 9 is a graph illustrating the peel strength based on the CTS test at each sampling weld point sampled for every predetermined number of times by repeatedly performing spot welding;

FIG. 10 is a graph illustrating a test result shown in FIG. 9 as a distribution of the peel strength relative to the nugget diameter;

FIG. 11 illustrates a CT image of a weld nugget cut along the interface of a test piece according to a first example;

FIG. 12 illustrates a CT image of a weld nugget cut along the interface of a test piece according to a first comparative example;

FIG. 13 illustrates a CT image of a weld nugget cut along the interface of a test piece according to a second comparative example;

FIG. 14 illustrates a CT image of a weld nugget cut, along the interface of a test piece according to a third comparative example;

FIG. 15 illustrates a CT image of a weld nugget cut along the interface of a test piece according to a second example;

FIG. 16 is a cross-sectional view of the test piece according to the second example shown in FIG. 15, taken in the plate-thickness direction;

FIG. 17 illustrates a CT image in a cross section of a plate surface of a test piece according to a fourth comparative example;

FIG. 18 is a cross-sectional view of the test piece according to the fourth comparative example shown in FIG. 17, taken in the plate-thickness direction;

FIG. 19 illustrates a CT image in a cross section of a plate surface of a test piece according to a third example;

FIG. 20 is a cross-sectional view of the test piece according to the third example shown in FIG. 19, taken in the plate-thickness direction;

FIG. 21 illustrates a CT image of a weld nugget cut along the interface of a test piece according to a fifth comparative example; and

FIG. 22 is a cross-sectional view of the test piece according to the fifth comparative example shown in FIG. 21, taken in the plate-thickness direction.

### DESCRIPTION OF THE PREFERRED EMBODIMENT

An embodiment of the present invention will be described in detail below with reference to the drawings.

### Spot Welding Device

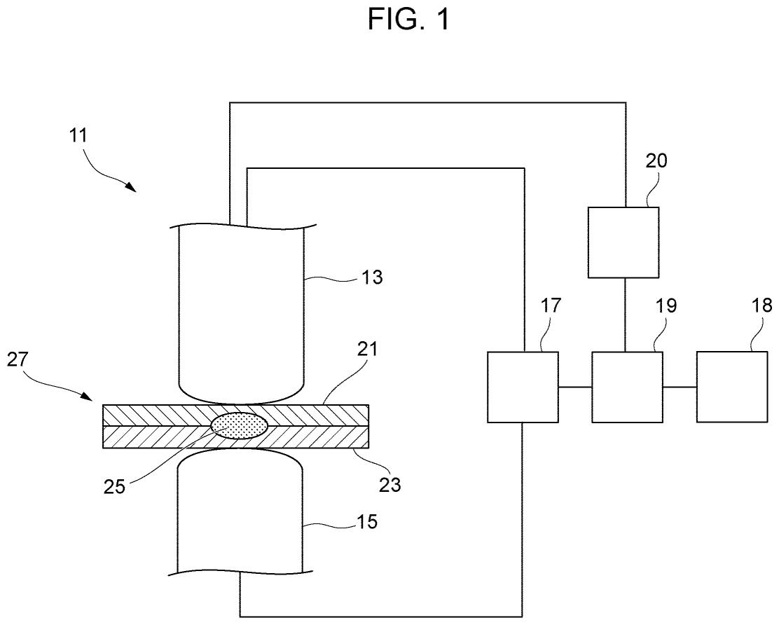

FIG. 1 schematically illustrates the configuration of a spot welding device that welds aluminum members together by resistance spot welding. 7

A spot welding device 11 includes a pair of electrodes 13 and 15, a welding transformer 17 connected to the pair of electrodes 13 and 15, a power supply 18, a controller 19 that supplies welding power from the power supply 18 to the welding transformer 17, and an electrode driver 20 that relatively moves the pair of electrodes 13 and 15 in an axial direction. The controller 19 comprehensively controls, for example, the electric current value, the electric-current application period, the pressing force of the electrodes, the electric-current application timing, and the pressing timing.

The spot welding device 11 clamps at least two plates, including a first aluminum plate 21 and a second aluminum plate 23, in a layered fashion between the pair of electrodes 13 and 15. Then, the electrodes 13 and 15 are driven by the electrode driver 20, so that the first, aluminum plate 21 and the second aluminum plate 23 are pressed against each other in the thickness direction thereof. In this pressed state, the welding transformer 17 applies electric current between the electrodes 13 and 15 based on a command from the controller 19. Consequently, a weld nugget 25 is formed at the interface between the first aluminum plate 21 and the second aluminum plate 23 clamped between the electrodes 13 and 15, so that the first aluminum plate 21 and the second aluminum plate 23 are combined with each other, whereby a resistance-spot-welded aluminum joint 27 is obtained.

Although the resistance-spot-welded aluminum joint 27 is obtained by joining two aluminum plates in the above example, the present invention is not limited to the case where two aluminum plates are to be joined, and may be suitably applied to a case where three or more aluminum plates are to be joined.

In the following description, the layered direction of the first aluminum plate 21 and the second aluminum plate 23 may also be referred to as a plate-thickness direction or a thickness direction of the weld nugget 25 (i.e., a depth direction of fusion). With regard to the weld nugget 25, the direction that is orthogonal to the aforementioned layered direction and in which the nugget extends radially from the center thereof will be defined as a “nugget radial direction”, and the maximum diameter in the direction orthogonal to the thickness direction of the weld nugget 25 will be defined as a “nugget diameter”. The thickness direction of the weld nugget 25 is the same as the plate-thickness direction of the first aluminum plate 21 and the second aluminum plate 23.

### First Aluminum Member and Second Aluminum Member

A first aluminum member and a second aluminum member may be composed of any type of aluminum or an aluminum alloy. In particular, a 5000-series, 6000-series, or 7000-series aluminum alloy in which blowholes tend to form easily is preferably used. Other examples that can be used include 2000-series, 3000-series, 4000-series, and 8000-series aluminum alloys, as well as 1000-series pure aluminum.

The aluminum members may each be a cast member, in addition to an aluminum plate, an extruded member, and a forged member. A preferred example of a cast member used has improved casting quality by using precision casting or overflow to reduce blowholes existing in a base material as much as possible.

Normally, in a resistance-spot-welded aluminum joint, it is difficult to completely eliminate blowholes caused by spot welding. The occurrence of blowholes is notable especially in alloys containing large quantities of magnesium and zinc, which are elements with low vapor pressure, as in 5000-series, 6000-series, and 7000-series aluminum alloys, and it, is difficult to reduce such blowholes.

As a result of a keen examination on changes in weld strength caused by blowholes mentioned above, the present inventor has discovered that the type of blowholes, instead of the area of blowholes, exhibits a large effect for suppressing variations in the cross tension strength (CTS).

### Aggregation of Blowholes

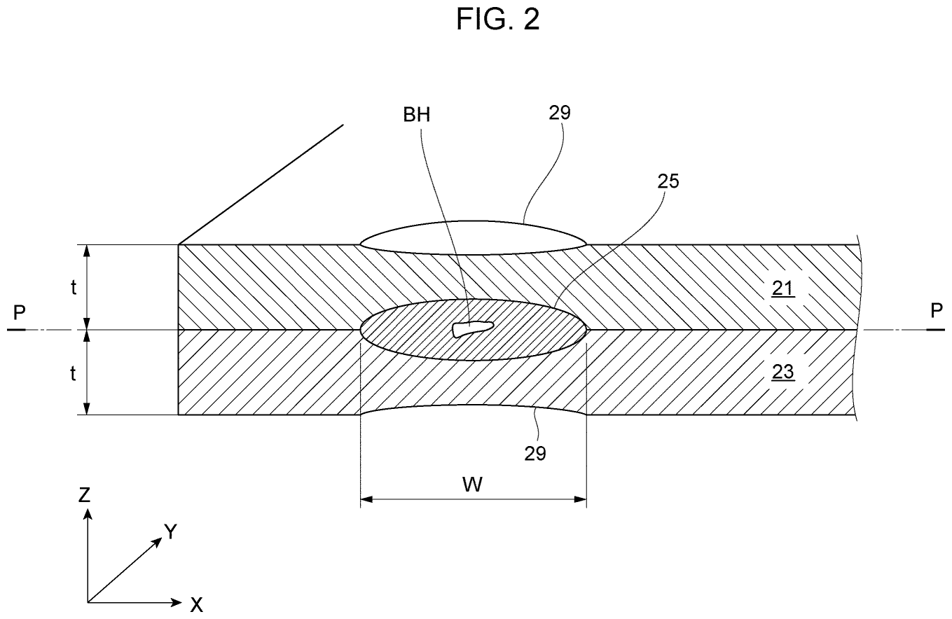

FIG. 2 is a cross-sectional view schematically illustrating a state where the weld nugget 25 is formed as a result of layering the first aluminum plate 21 and the second aluminum plate 23 and welding the two plates together by spot welding. The layered direction of the first aluminum plate 21 and the second aluminum plate 23 will be defined as a Z direction, and the plate-surface directions orthogonal to the Z direction will be referred to as an X direction and a Y direction. The X direction and the Y direction are orthogonal to each other.

The weld nugget 25 formed has a nugget width W, in a plate-surface direction, in a region including the interface between the first aluminum plate 21 and the second aluminum plate 23 each having a thickness t. Furthermore, dents 29 are formed on the outer plate surfaces of the first aluminum plate 21 and the second aluminum plate 23 by being pressed by the electrodes 13 and 15 shown in FIG. 1.

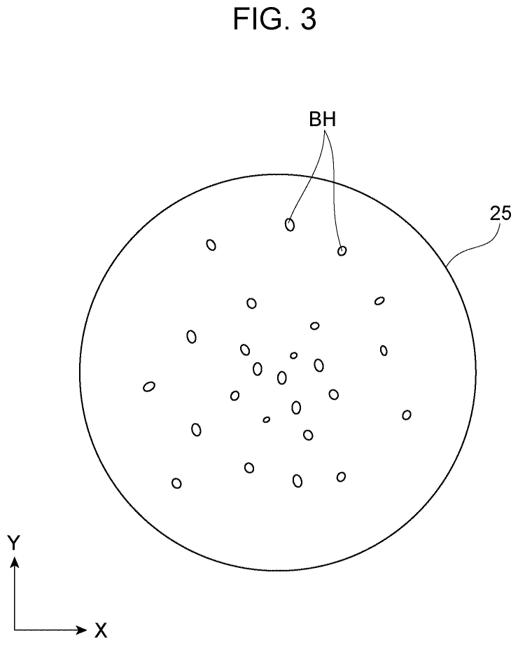

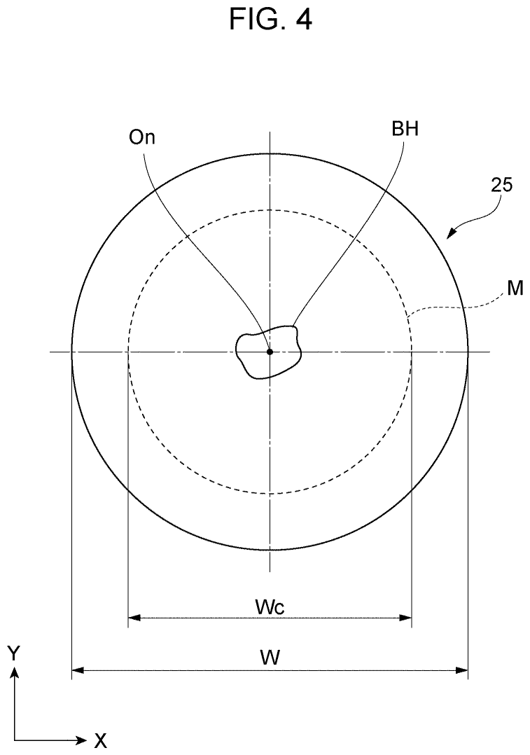

FIGS. 3 and 4 are cross-sectional views schematically illustrating the weld nugget, taken along line P-P in FIG. 2 indicating the interface between the aluminum members.

The weld nugget 25 has a large number of blowholes BH of various sizes. Since the aluminum members have high thermal conductivity, the weld nugget 25 is formed within a short period of time after the aluminum members are supplied with electric current. Therefore, the blowholes BH tend to be dispersed in the weld nugget 25, as shown in FIG. 3.

In a CTS test, the resistance-spot-welded aluminum members are pulled in directions in which they are peeled from each other. Thus, when the blowholes BH are dispersed in the weld nugget 25, as shown in FIG. 3, even if each of the blowholes BH has a small area (volume), peeling occurs easily even with a low load, starting from blowholes BH located near the outer periphery of the weld nugget 25.

As shown in FIG. 4, in a plan view of the weld nugget 25 at the interface between the aluminum members, the blowholes BH are aggregated near a nugget center On. Accordingly, even if the area (volume) of each blowhole BH is large, there are hardly any blowholes BH near the outer periphery of the weld nugget 25. Therefore, the blowholes BH that may become an origin of peeling can be reduced, so that stable CTS can be obtained.

With regard to the aggregated state of the blowholes BH, in a cross section of the weld nugget 25 taken along the aforementioned interface, it is desirable that all of the blowholes BH be formed in an inner region M having a diameter We that is 70% or smaller, preferably 75% or smaller, and more preferably 80% or smaller of the nugget width W of the weld nugget 25 from the nugget center On. Furthermore, it is desirable that the inner region M have one blowhole BH or a maximum of three blowholes BH larger in size than the other blowholes, rather than having micro-blowholes dispersed therein. Moreover, it is desirable that the blowhole or blowholes BH be formed at a position on a center line of the weld nugget 25 extending in the aforementioned layered direction of the aluminum members. Specifically, if there are other blowholes in addition to the largest blowhole, it is preferable that the other blowholes be micro-blowholes with a size of 1/20 or smaller, preferably 1/30 or smaller, and more preferably 1/50 or smaller of the size of the largest blowhole.

### Spot Welding Method

A weld nugget having a blowhole, as shown in FIG. 4, can be obtained by, for example, applying a weld current continuously for a predetermined period and subsequently applying a pulse current a plurality of times. With this electric-current application method, the weld nugget obtained has coagulated parts and shells, to be described in detail later, alternately disposed therein, so that blowholes can be aggregated in a central area of the weld nugget.

### Welding Conditions

Next, a method for forming a weld nugget in accordance with the aforementioned electric-current application method will be described.

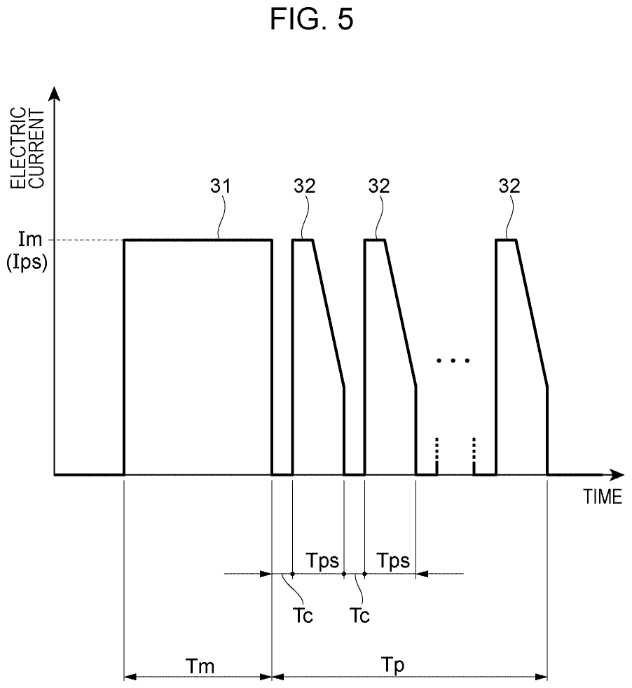

The controller 19 shown in FIG. 1 applies electric current between the pair of electrodes 13 and 15 from the welding transformer 17 at a predetermined timing. FIG. 5 is a timing chart illustrating an example of a waveform of a weld current.

The waveform of the weld current shown in FIG. 5 may include a main electric-current application step in an electric-current application period Tₘ in accordance with continuous electric-current application 31 at a first stage and a pulsation electric-current application step in which electric current is repeatedly applied in pulses (short pulses) 32 with a short electric-current application period. The pulsation electric-current application involves repeating a pause (pause period T_{c}) and a process of applying a pulse 32 of electric current (electric-current application period Tₚₛ) for a plurality of times during an overall electric-current application period Tₚ. The electric-current waveform of the continuous electric-current, application 31 at the first stage and the pulse 32 at the second stage may be rectangular, may be a waveform having another shape, such as a triangular shape or a sinusoidal shape, or may be a downslope-controlled or upslope-controlled waveform. In the example shown in FIG. 5, the continuous electric-current application 31 corresponds to a constant electric-current waveform, and the pulse 32 corresponds to a waveform in which a rectangular pulse has been downslope-controlled. If the electric-current waveform of the pulsation electric-current application is a waveform other than a rectangular waveform, such as a downslope-controlled or upslope-controlled waveform, the maximum electric-current value in each pulse wave is defined as the electric-current value of the pulsation electric-current application. An electric-current value Iₚₛ of the pulsation electric-current application is not limited to a case where it is equal to an electric-current value Iₘ of the continuous electric-current application 31, and may be larger than the electric-current value Iₘ.

The electric-current value Iₘ of the continuous electric-current application 31 at the first stage and the electric-current value Iₚₛ of the pulse 32 at the second stage and onward are both set within a range of 15 kA to 60 kA. The final nugget size is substantially determined in accordance with the electric current applied based on the electric-current value Iₘ of the continuous electric-current application 31. Therefore, an optimal electric-current value Iₘ may be set in accordance with the welding purpose.

The electric-current value Iₘ of the continuous electric-current application 31 preferably ranges between 30 kA and 40kA. The electric-current application period Tₘ is between 100 ms and 300 ms, preferably between 150 ms and 250 ms, and more preferably between 180 ms and 220 ms.

The electric-current value for the pause period T_{c} when the electric-current application is at pause is 0 A since no electric current is applied between the electrodes 13 and 15 in the example shown in FIG. 5, but is not necessarily limited to 0 A. The electric-current value may be higher than 0 A so long as the amount of heat input to the first aluminum plate 21 and the second aluminum plate 23 can be reduced relative to that during the electric-current application. The pause period T_{c} is between 10 ms and 20 ms, preferably between 10 ms and 15 ms, and more preferably between 10 ms and 12 ms.

The electric-current value Iₚₛ of each pulse 32 preferably ranges between 30 kA and 40 kA. The electric-current application period Tₚₛ is between 10 ms and 30 ms, preferably between 15 ms and 25 ms, and more preferably between 18 ms and 22 ms. The number of times the pulses 32 are repeatedly applied (i.e., the number N of pulses) is three or more, preferably four or more, and more preferably seven or more.

### Procedure and Effect of Resistance Spot Welding

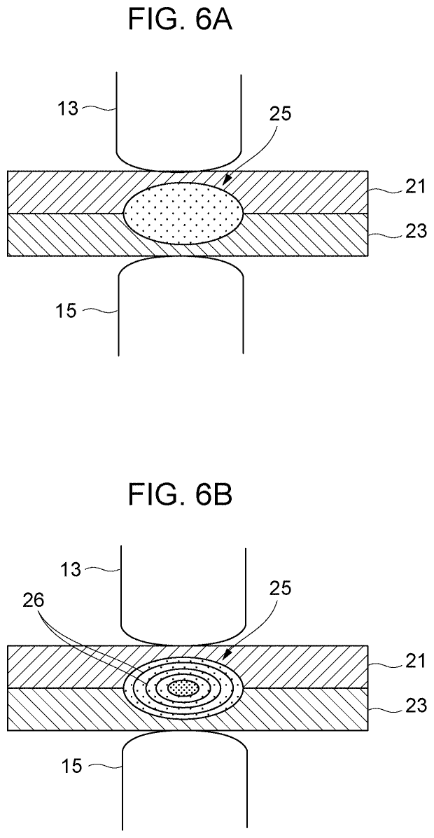

FIGS. 6A and 6B schematically illustrate the state of the nugget from the main electric-current application at the first stage to the pulsation electric-current application at the second stage.

As shown in FIG. 6A, when the electric-current value Iₘ is applied to the first aluminum plate 21 and the second aluminum plate 23 clamped between the pair of electrodes 13 and 15 during the main electric-current application, the weld nugget 25 is formed at the interface between the plates.

Subsequently, as shown in FIG. 6B, when the pulsation electric-current application based on a plurality of short pulses is executed, a plurality of shells 26 that are ring-shaped in cross section are formed inside the weld nugget 25. When a cross section of the weld nugget 25 taken in the plate-thickness direction is observed, a striped pattern of the shells 26 arranged concentrically from the center of the weld nugget 25 can be observed within the weld nugget 25.

By repeating the pulsation electric-current application (i.e., an electric-current application process and a cooling process) a plurality of times after the main electric-current application, coagulated parts, which are columnar crystals, and the shells 26 are alternately formed toward the center of the nugget. When a cross section of the weld nugget 25 taken in the plate-thickness direction is observed after the pulsation electric-current application, a striped pattern of the shells 26 concentrically formed as multiple layers of rings is observed, as schematically shown in FIG. 6B.

In accordance with the procedure of resistance spot welding described above, the weld nugget 25 has the plurality of shells 26 formed toward the center of the nugget, so that fused bodies surrounded by the shells 26 decrease in size in a stepwise fashion toward the center. Therefore, even when blowholes occur in a nugget as a result of resistance spot welding, the blowholes are aggregated in the central area of the nugget.

As mentioned above, when a blowhole exists near a joint section or a base material of an aluminum member (i.e., the outer periphery of a nugget), the weld quality is likely to decrease since the blowhole may act as an origin of breakage. In contrast, even when a blowhole exists at the center of the nugget where stress concentration is less likely to occur, the blowhole does not have a significant effect on the weld quality, such as the joint strength.

According to this resistance spot welding method, blowholes are aggregated in the central area of a weld nugget as a result of performing pulsation electric-current application, so that deterioration in the quality of the welded section can be prevented. Thus, even if the aluminum members used contain magnesium and zinc, which are elements with low vapor pressure, and are materials in which blowholes tend to form easily, such as 5000-series, 6000-series, or 7000-series aluminum, variations in the CTS caused by blowholes can be suppressed.

### Other Spot Welding Methods

In addition to the above-described method, examples of other methods for stabilizing the CTS by reducing the dispersion of blowholes include a method of replacing, dressing, or abrading the electrodes while the number of weld points is still small, and a method of controlling the pressing force from the electrodes in accordance with the weld current.

For example, in a 6000-series aluminum alloy, the electrodes are replaced when the number of weld points reaches 60, preferably 50, in spot welding, so that irregularities in the profile of the electrode surfaces are suppressed, whereby stable spot welding can be constantly performed. As a result, a weld nugget can be stably formed, and variations in the CTS can be suppressed.

### EXAMPLES

### First Example

A CTS test is executed on a test piece (i.e., a resistance-spot-welded joint) obtained by spot welding a pair of aluminum plates in a cross pattern. Table 1 shows the material and process of the test piece used, the shape of each plate, and the shape of the joint.

TABLE 1

| | | |
|---|---|---|
| Test | Material and | 6000-Series Aluminum Alloy, T4 Treatment |
| Piece | Process | (Surface Degreasing Prior to Welding) |
| | Shape of Each | 50 mm (Width) × 150 mm (Length) × 2.0 mm |
| | Plate | (Thickness) |
| | Shape of Joint | JIS Z3137 Compliant |

Furthermore, Table 2 and Table 3 show the welding conditions for spot welding. In a pre-pressing period, the pair of aluminum plates are clamped between the electrodes with a pressing force of 5 kN for 100 ms. With regard to the electric-current application conditions, an electric current of 25 kA is applied for 200 ms when the nugget diameter is 4.0√t (t being the thickness of each aluminum plate), and an electric current of 38 kA is applied for 200 ms when the nugget diameter is 6.0It. After the electric-current application (i.e., the main electric-current application), the welding process is terminated after a holding period of 200 ms. The pressing force from the electrodes is maintained constant from the pre-pressing period to the holding period.

TABLE 2

| | | Pre-Pressing | Electric-Current | Holding |
|---|---|---|---|---|
| | | Period | Application Period | Period |
| Welding | Electric Current | 0 | 25 (4.0 √t Target) | 0 |
| Conditions | (kA) | | 38 (6.0 √t Target) | |
| | Time (ms) | 100 | 200 | 200 |

| | |
|---|---|
| Pressing Force | 5 |
| (kN) | |

TABLE 3

| | | |
|---|---|---|
| Electrodes | Shape | R-Type: Tip Diameter ϕ 19 mm, |
| | | Radius of Curvature at Tip: R100 mm |
| | Material | Chromium Copper |
| Coolant | Temperature | 24° C. |
| | Flow Rate | 4 L/min |

The CTS test is executed by using a tensile testing device (model 5900A 5581) manufactured by Instron Corporation while setting the tension speed to 10 mm/min. For fastening the test piece to a test-piece securing jig by using bolts, a torque wrench is used with a tightening torque of 80 Nm.

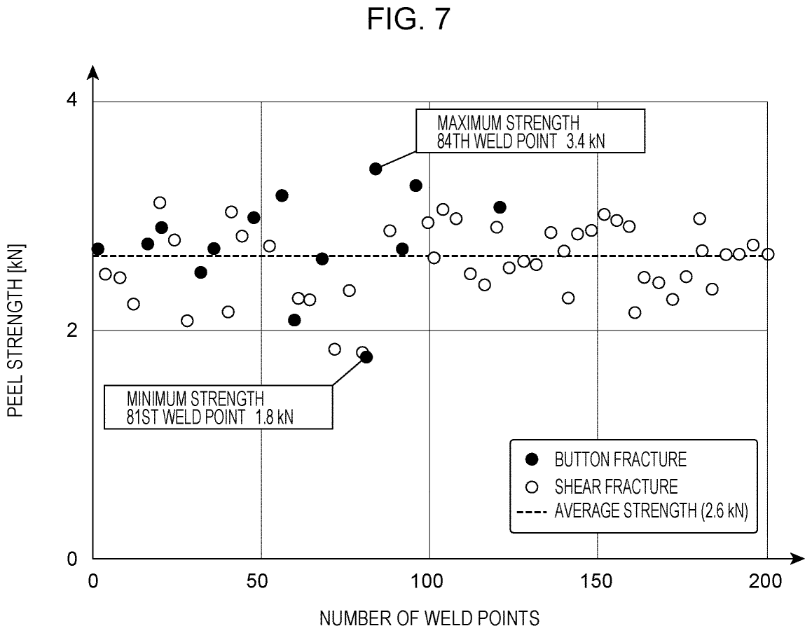

FIG. 7 is a graph illustrating the peel strength based on the CTS test at each sampling weld point sampled for every predetermined number of times by repeatedly performing spot welding. This graph is a result obtained when the nugget size is set to 4.0√t.

An average value of the peel strength is 2.6 kN. The types of fracture occurring at the joint surface up to about 120 weld points include a button fracture and a shear fracture, but only a shear fracture occurs when the number of weld points exceeds 120. This is conceivably because the tip of each electrode becomes abraded or deformed as the number of weld points in spot welding increases, resulting in reduced weldability.

The maximum value and the minimum value of the peel strength are 3.4 kN and 1.8 kN, respectively, and the type of fracture is a button fracture for both values. Specifically, a variation at a maximum of about 1.9 times has occurred in the peel strength, regardless of whether the type of fracture is a button fracture or a shear fracture.

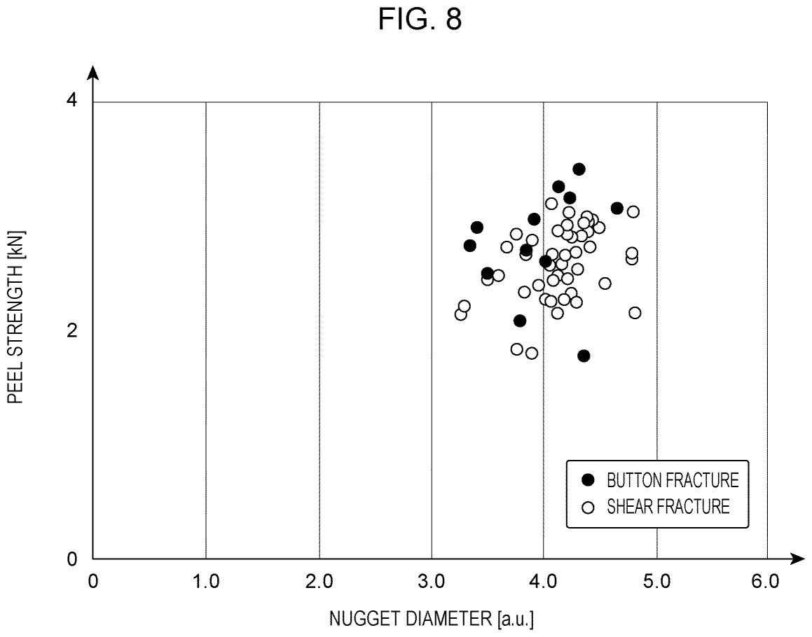

FIG. 8 is a graph illustrating the test result shown in FIG. 7 as a distribution of the peel strength relative to the nugget diameter. It is clear from the results shown in FIGS. 7 and 8 that the peel strength is not necessarily dependent on the nugget, diameter of the weld nugget or the type of fracture.

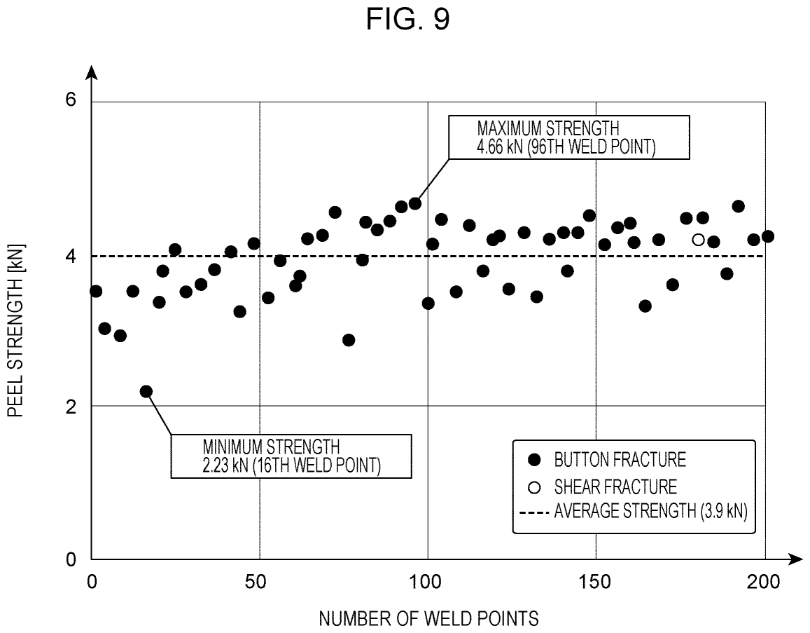

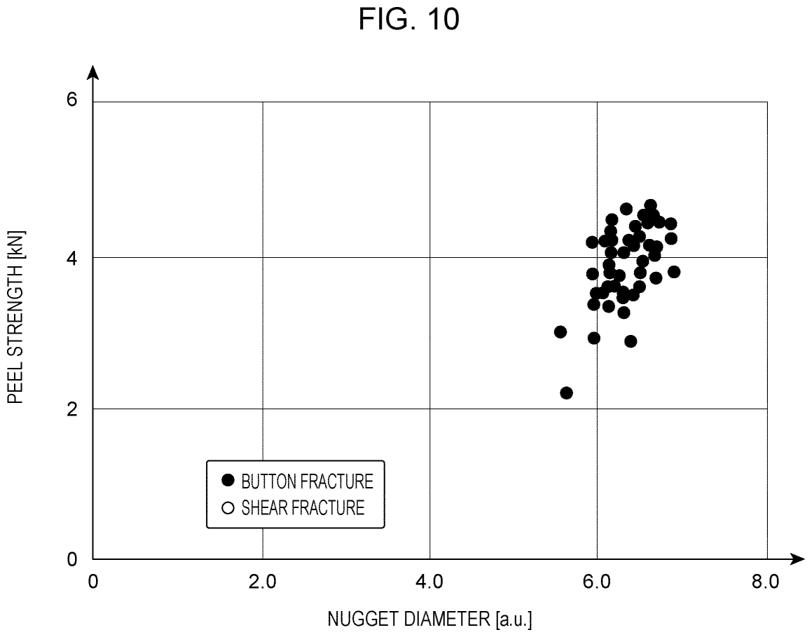

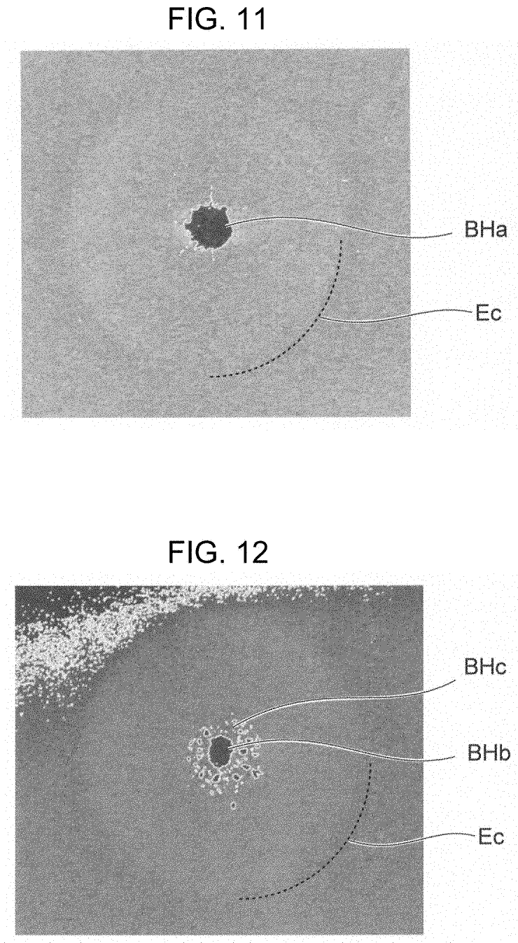

FIG. 9 is a graph illustrating the peel strength based on the CTS test at each sampling weld point sampled for every predetermined number of times by repeatedly performing spot welding. This graph is a result obtained when the nugget size is set to 6.0√t. FIG. 10 is a graph illustrating the test result shown in FIG. 9 as a distribution of the peel strength relative to the nugget diameter.

In the case of FIGS. 9 and 10, the average value of the peel strength is 3.9 kN, the maximum value and the minimum value of the peel strength are 4.66 kN and 2.23 kN, respectively, and the type of fracture is mostly a button fracture. In this case, a variation at a maximum of about 2.1 times has occurred in the peel strength.

### Type of Blowholes

The following description relates to results obtained by checking the positions where blowholes are formed in a weld nugget and the distribution type thereof from a CT-photographed cross-sectional image of a spot-welded section of the aforementioned test piece. Table 4 shows the details of an X-ray CT scanning device and the photographing conditions for a CT image.

TABLE 4

| | | |
|---|---|---|
| X-Ray CT | Voltage [kV] | 205 |
| Photographing | Electric Current [mA] | 180 |
| Conditions | Exposure Time [ms] | 708 |
| | Filter | Copper Material with Thickness |
| | | of 0.5 mm |

### Center of Nugget and Center of Blowholes in Cross Section of Interface Between Aluminum Members

Among the test pieces with the nugget size set to 6.0√t shown in FIGS. 9 and 10, the test piece corresponding to the twenty-fourth weld point is defined as the first example, the test piece corresponding to the twelfth weld point is defined as a first comparative example, the test piece corresponding to the first weld point is defined as a second comparative example, and the test piece corresponding to the twentieth weld point is defined as a third comparative example.

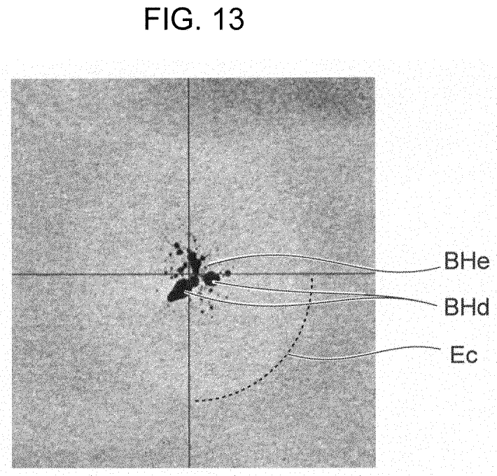

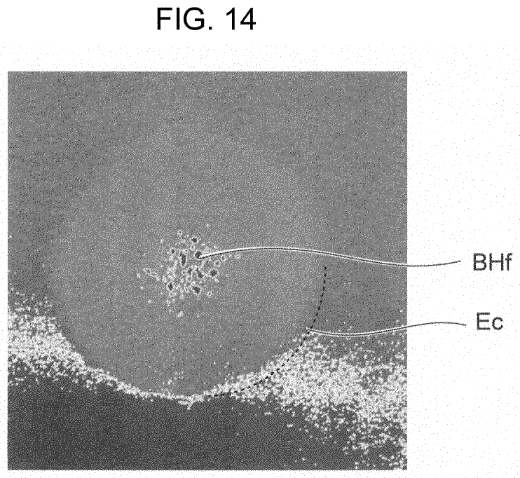

FIG. 11 illustrates a CT image of a weld nugget cut along the interface of the test piece according to the first example. FIG. 12 illustrates a CT image of a weld nugget cut along the interface of the test piece according to the first comparative example. FIG. 13 illustrates a CT image of a weld nugget cut along the interface of the test piece according to the second comparative example. FIG. 14 illustrates a CT image of a weld nugget cut along the interface of the test piece according to the third comparative example. The cut positions in FIGS. 11 to 14 correspond to line P-P shown in FIG. 2. A dent circle Ec as the outer periphery of each dent 29 shown in FIG. 2 is confirmed around a blowhole or blowholes BH in each CT image. The dent circle Ec is concentric with the weld nugget 25.

In the first example shown in FIG. 11, a single aggregated blowhole BH is formed at the center of the dent circle Ec. Specifically, a blowhole RHa extends through the center of the weld nugget.

In the first comparative example shown in FIG. 12, a medium-size blowhole BHb smaller than the blowhole BHa in FIG. 11 is formed at the center of the dent circle Ec, and a large number of small-size blowholes BHc smaller than the blowhole BHb surround the blowhole BHb.

In the second comparative example shown in FIG. 13, a plurality of middle-size blowholes BHd are formed near the center of the dent circle Ec, and a large number of small-size blowholes BHe are dispersed around the blowholes BHd.

In the third comparative example shown in FIG. 14, a large number of small-size blowholes BHf are dispersed around the center of the dent circle Ec.

The evaluation results according to the first example and the first to third comparative examples are collectively shown on Table 5. The peel strength in the first example is 4.05 kN and is higher than the peel strength of 3.49 kN in the first comparative example, the peel strength of 3.50 kN in the second comparative example, and the peel strength of 3.36 kN in the third comparative example. In any of these cases, the type of fracture is a button fracture.

TABLE 5

| | | | | Peel |
|---|---|---|---|---|
| | Blowholes | | Type of | Strength |
| | Position | Size | Fracture | [kN] |
| First | Aggregated at | Large Size Only | Button | 4.05 |
| Example | Center of Nugget | | | |
| Second | Aggregated at | Large Size Only | Button | 3.40 |
| Example | Center of Nugget | | | |
| Third | Aggregated at | Mixture of Medium | Button | 4.66 |
| Example | Center of Nugget | Size and Small Size | | |
| First | Dispersed Near | Mixture of Large | Button | 3.49 |
| Comparative | Center of Nugget | Size and Small Size | | |
| Example | | | | |
| Second | Aggregated at | Mixture of Medium | Button | 3.50 |
| Comparative | Center of Nugget | Size and Small Size | | |
| Example | | | | |
| Third | Dispersed Near | Mostly Small Size | Button | 3.36 |
| Comparative | Center of Nugget | | | |
| Example | | | | |
| Fourth | Eccentric from | Large Size Only | Button | 1.80 |
| Comparative | Center of Nugget | | | |
| Example | | | | |
| Fifth | Eccentric from | Large Size | Button | 2.88 |
| Comparative | Center of Nugget | | | |
| Example | | | | |

### Center of Nugget and Center of Blowhole in Cross Section Taken in Layered Direction of Aluminum Members

Among the test pieces with the nugget size set to 4.0√t shown in FIGS. 7 and 8, the test piece corresponding to the eighty-fourth weld point is defined as a second example, and the test piece corresponding to the eighty-first weld point is defined as a fourth comparative example.

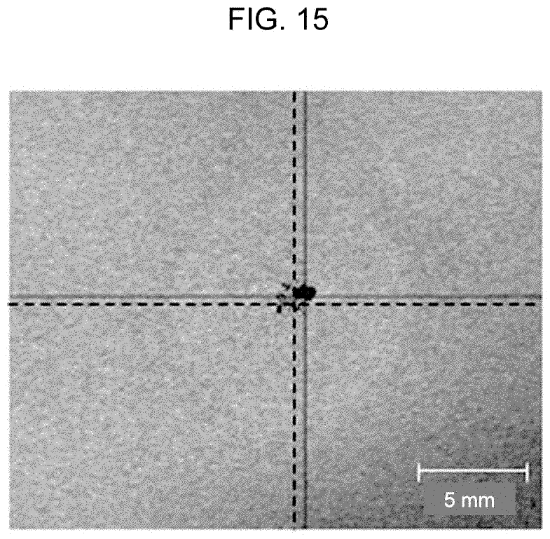

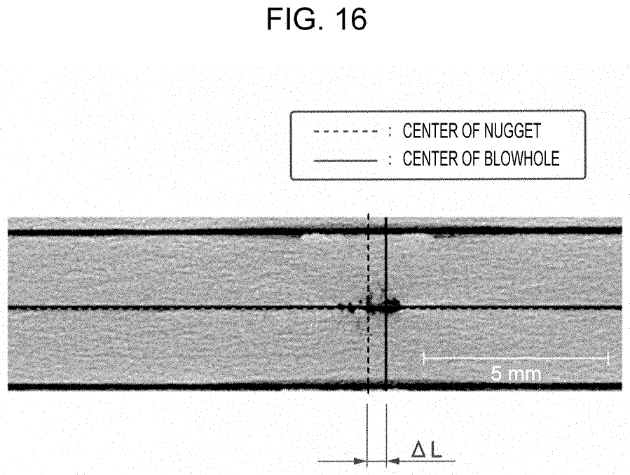

FIG. 15 illustrates a CT image of a weld nugget cut along the interface of the test piece according to the second example. FIG. 16 is a cross-sectional view of the test piece according to the second example shown in FIG. 15, taken in the plate-thickness direction.

FIGS. 15 and 16 indicate the center of the weld nugget with a dotted line and the center of a blowhole with a solid line. The blowhole in the second example is offset from the center of the nugget by an offset amount ΔL of 0.32 mm and is formed at a position where the blowhole extends through the center line of the weld nugget. A result of a CTS test indicates that the peel strength is 3.4 kN and the type of fracture is a button fracture.

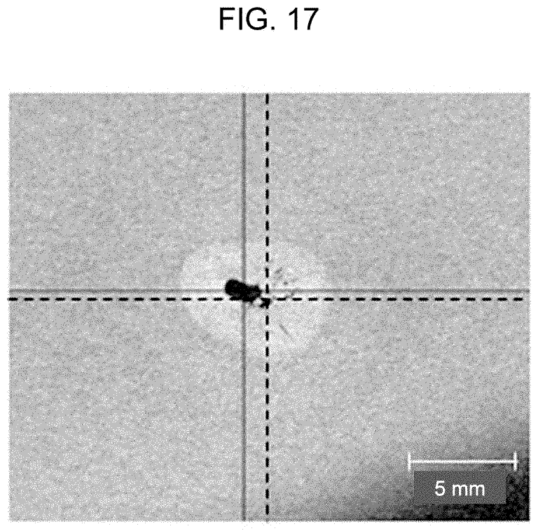

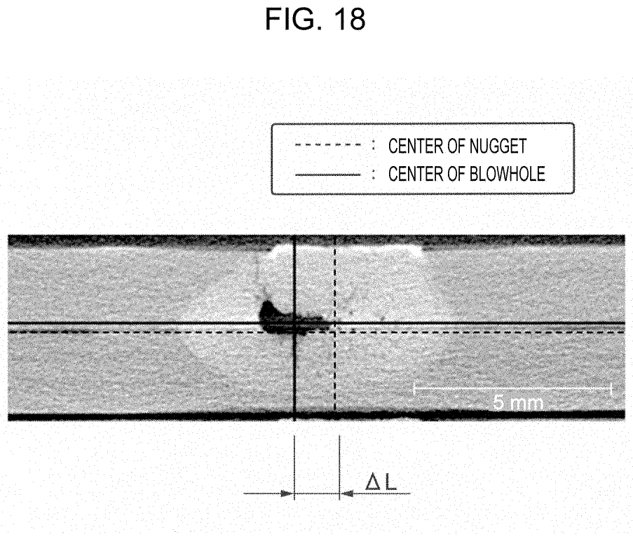

FIG. 17 illustrates a CT image of a weld nugget cut along the interface of the test piece according to the fourth comparative example. FIG. 18 is a cross-sectional view of the test piece according to the fourth comparative example shown in FIG. 17, taken in the plate-thickness direction.

A blowhole in the fourth comparative example is offset from the center of the nugget by an offset amount ΔL of 1.04 mm, is larger than that in the second example, and is formed at a position where the blowhole does not intersect with the center line of the weld nugget. A result of a CTS test indicates that the peel strength is 1.8 kN and the type of fracture is a button fracture. The volume of the blowhole in the second example is 0.57 mm³, and the volume of the blowhole in the fourth comparative example is 0.59 mm³. This indicates that there is no significant difference between the volumes of the two blowholes.

Among the test pieces with the nugget size set to 6.0√t shown in FIGS. 9 and 10, the test piece corresponding to the ninety-sixth weld point is defined as a third example, and the test piece corresponding to the seventy-sixth weld point is defined as a fifth comparative example.

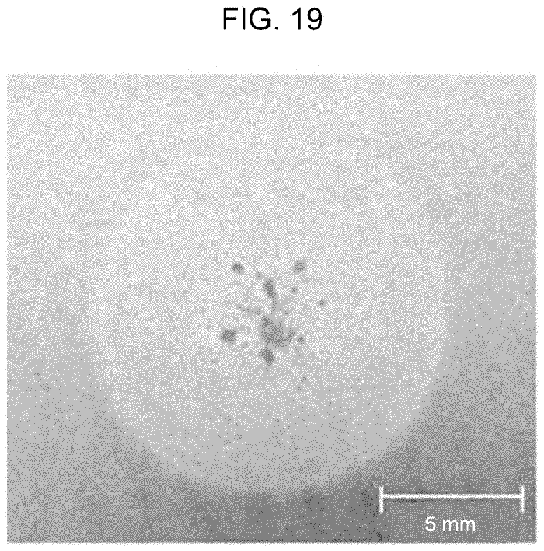

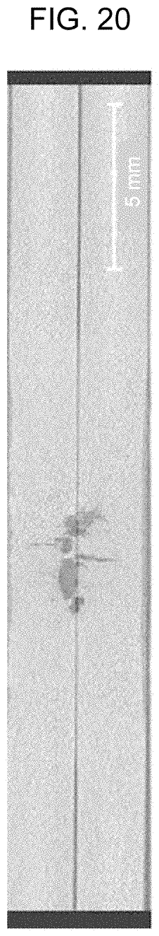

FIG. 19 illustrates a CT image of a weld nugget cut along the interface of the test piece according to the third example. FIG. 20 is a cross-sectional view of the test piece according to the third example shown in FIG. 19, taken in the plate-thickness direction.

A blowhole in the third example is offset from the center of the nugget by an offset amount ΔL of 0.58 mm and is formed at a position where the blowhole extends through the center line of the weld nugget. A result of a CTS test indicates that the peel strength is 4.66 kN and the type of fracture is a button fracture.

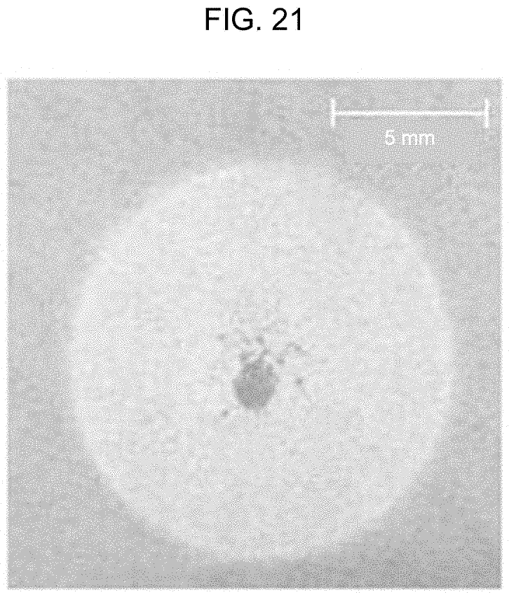

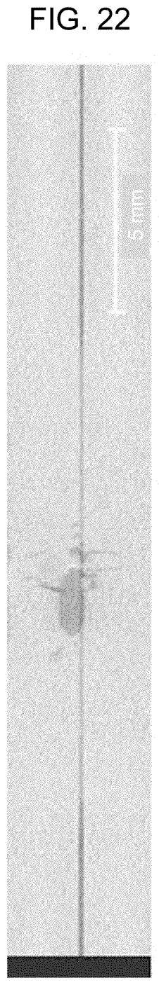

FIG. 21 illustrates a CT image of a weld nugget cut along the interface of the test piece according to the fifth comparative example, and FIG. 22 is a cross-sectional view of the test piece according to the fifth comparative example shown in FIG. 21, taken in the plate-thickness direction.

A blowhole in the fifth comparative example is offset from the center of the nugget by an offset amount ΔL of 0.92 mm and is formed at a position where the blowhole does not intersect with the center line of the weld nugget. A result of a CTS test indicates that the peel strength is 2.88 kN and the type of fracture is a button fracture. The volume of the blowhole in the third example is 5.44 mm³, and the volume of the blowhole in the fifth comparative example is 5.44 mm³. This indicates that there is no significant difference between the volumes of the two blowholes.

It is clear from the results obtained in the second and third examples and the third and fourth comparative examples that the peel strength is high when a blowhole with the maximum size is formed where it extends through the center line of the weld nugget, and that the peel strength is low when such a blowhole does not intersect with the center of the nugget.

The evaluation results according to the first to third examples and the first to fifth comparative examples are collectively shown on Table 5.

In each of the examples and the comparative examples, the type of fracture is a button fracture, the peel strength in each of the first to third examples ranges between 3.40 kN and 4.66 kN, and the peel strength in each of the first to fifth comparative examples ranges between 1.80 kN and 3.50 kN. With regard to the peel strength, the average value in each of the first to third examples is higher than the average value in each of the first to fifth comparative examples.

The present invention is not limited to the above-described embodiment. The components in the embodiment may be combined, or may be modified or applied by a skilled person based on the description as well as a known technology. Such a combination, modification, or application is intended in the present invention and is included in the scope to be protected.

Accordingly, the following items are disclosed in this description.

According to a first item, a resistance-spot-welded aluminum joint is obtained by layering a plurality of aluminum members and welding the aluminum members together by resistance spot welding. In a cross section of an interface between the aluminum members, a weld nugget formed as a result of the resistance spot welding has a plurality of blowholes aggregated in a central area of the weld nugget within the interface. In a cross section taken in a layered direction of the aluminum members extending through a center of the weld nugget, a blowhole with a maximum size of the plurality of blowholes is formed at a position where the blowhole extends through a center line of the weld nugget extending in the layered direction.

According to this resistance-spot-welded aluminum joint, the blowholes are aggregated in the central area of the weld nugget. Thus, as compared with a case where the blowholes exist along the outer periphery of the weld nugget, the peel strength (i.e., the CTS) between the aluminum members can be increased, and variations in the CTS can be reduced even when the type of fracture is a button fracture.

According to a second item, in the resistance-spot-welded aluminum joint according to the first item, at least one of the remaining blowholes excluding the blowhole with the maximum size is a micro-blowhole with a size of 1/20 or smaller of the blowhole with the maximum size.

According to this resistance-spot-welded aluminum joint, a blowhole that is larger than a micro-blowhole is formed at the center of the weld nugget, so that variations in the CTS can be further reduced.

According to a third item, in the resistance-spot-welded aluminum joint according to the first or second item, in the cross section of the interface of the weld nugget, the plurality of blowholes are disposed in a radius range of 70% or smaller of a nugget width from the center of the weld nugget.

According to this resistance-spot-welded aluminum joint, since there are no blowholes that are located along the outer periphery of the nugget and that may cause a shear fracture in the weld nugget and reduce the peel strength, the type of fracture is stably a button fracture when the aluminum members peel away from each other, whereby high joint strength can be obtained.

1. A resistance-spot-welded aluminum joint obtained by layering a plurality of aluminum members and welding the aluminum members together by resistance spot welding,
wherein, in a cross section of an interface between the aluminum members, a weld nugget formed as a result of the resistance spot welding has a plurality of blowholes aggregated in a central area of the weld nugget within the interface, and
wherein, in a cross section taken in a layered direction of the aluminum members extending through a center of the weld nugget, a blowhole with a maximum size of the plurality of blowholes is formed at a position where the blowhole extends through a center line of the weld nugget extending in the layered direction.

2. The resistance-spot-welded aluminum joint of claim 1,
wherein at least one of the blowholes, other than the blowhole with the maximum size, is a micro-blowhole with a size of 1/20 or smaller of the blowhole with the maximum size.

3. The resistance-spot-welded aluminum joint of claim 1,
wherein, in the cross section of the interface of the weld nugget, the plurality of blowholes are disposed in a radius range of 70% or smaller of a nugget width from the center of the weld nugget.
